(19) United States
(12) Patent Application Publication
(10) Pub. No.: US 2022/0400900 A1
(43) Pub. Date: Dec. 22, 2022

(54) GRILL CLEANER APPARATUS

(71) Applicant: Pierre Curtis Bowman, III, Mandeville, LA (US)

(72) Inventor: Pierre Curtis Bowman, III, Mandeville, LA (US)

(21) Appl. No.: 17/895,961

(22) Filed: Aug. 25, 2022

Related U.S. Application Data
(63) Continuation-in-part of application No. 17/306,173, filed on May 3, 2021.

(51) Int. Cl. A47J 37/07

(52) U.S. Cl. CPC A47J 37/0786; A46B 2200/3093

(57) ABSTRACT

A grill cleaner apparatus for cleaning a grill using rotary power from an external source such as a hand drill, having a drive shaft and cleaning wheels such as wire brush wheels, with two cleaning wheels rotating perpendicular to the drive shaft and cleaning grill bars and additionally propelling the grill cleaner forward.

### CROSS-REFERENCE TO RELATED APPLICATION

This application is a continuation-in-part of pending application Serial No. U.S. Ser. No. 17/306,173, filed on May 3, 2021, the full disclosure of which is incorporated by reference herein and priority of which is hereby claimed.

### BACKGROUND OF THE INVENTION

This invention provides a grill cleaner apparatus for cleaning a grill using rotary power from an external source such as a hand drill.

Existing powered grill cleaners can be expensive, clumsy, or ineffective at cleaning barbeque-type grills, especially when the grills are being used at remote locations. Grill cleaners powered with internal motors require either a source of electricity or the management of a grill-cleaner battery, and they are expensive, heavy, and subject to heat damage to the electrical components. In contrast, rotary power devices such as battery-powered hand drills are common, portable, and have battery management systems already existing.

Many grill cleaners fail to extend sufficiently far down through the grill bars to clean the lower parts of the bars, which can become thickly coated with baked-on residue. For the user, moving a powered grill cleaner along the grill bars at an optimal speed can be physically taxing because of the weight of the grill cleaner, the rotation of brushes counter to the direction of movement, trying to move too fast, or taking too long at the task by moving too slowly.

The brushes or cleaning surfaces of grill cleaners necessarily accumulate a lot of greasy charred residue, and must themselves be cleaned, which can be difficult where the brushes cannot be easily removed and reinstalled. Brushes will wear out or become damaged, and obtaining new special-design brushes can be expensive and cumbersome.

What is needed is a grill cleaner powered by an external source such as battery-powered hand drill, having brushes which reach sufficiently far down between grill bars, having brushes which can be easily removed for cleaning and inexpensively replaced when worn or damaged, and having self-propulsion to assist in moving across the grill bars.

Chinese Utility Model No. 2927822 for a “Brush for Roasting Frame,” issued on Aug. 1, 2007 to inventor DAI JIANGANG, discloses a roasting frame brush that comprises a handle and a brush head fixed with hard metal wires, characterized in that a casing, a driving mechanism inside the casing, the power supply portion and a control switch are further provided, the brush head is connected with the driving mechanism through a rotary shaft, driven by the driving mechanism, the driving mechanism, the power supply portion, and the control switch together form the driving circuit.

U.S. Pat. No. 4,299,004 for a “Powered Hand Tool For Use In Household Cleaning Operations,” issued on Nov. 10, 1981 to inventor Lorine E. Lancaster, provides for a tool including a water-tight housing of an elongated configuration having a handle defined therein, and an electrically energizable motor mounted in the housing and having a rotary output shaft therefor; a pair of wells spaced 90° apart are further provided in the housing as receptacles for a pair of sockets mounted on normally related drive shafts connected with the motor adapted to receive one of a plurality of polishing wheels mounted on shafts, whereby the polishing wheels are interchangeably related to the sockets.

German Utility Model No. 20 2009 004 156 for a “Electric Grill Cleaner,” published on Sep. 3, 2009 by inventor Herbert Prieschl, discloses an apparatus for cleaning grill grates or similar lattice-shaped articles, characterized in that the device is operated with electrical energy from the mains.

U.S. Pat. No. 9,161,612 for a “Surface-Cleaning Device,” issued on Oct. 20, 2015 to assignee Grillbot, LLC, provides for a device for cleaning a surface, such as a barbeque grill, having a substantially hollow enclosure that has at least a lower side, an upper side, and a peripheral edge, and contains a plurality of motors that each has a rotational shaft selectively fixable with a rotatable brush. At least a portion of bristles of each brush projects below a plane of the lower side of the enclosure. The enclosure further contains a power source and a circuit adapted for connecting power to each of the motors for a preset period of time upon actuation of an electrical switch connected thereto. The circuit is adapted to run each motor in a first direction and then an opposing direction, such that if the device becomes stuck at an obstruction, it will eventually turn around due to the alternating directions of the motors.

### SUMMARY OF THE INVENTION

This invention provides a grill cleaner apparatus for cleaning a grill using rotary power from an external source such as a hand drill, having a drive shaft and cleaning wheels such as wire brush wheels, with two cleaning wheels rotating perpendicular to the drive shaft and cleaning grill bars and additionally propelling the grill cleaner forward. A body unit houses the drive shaft supported by bearing supports with bearings. The cleaning wheels rotate on a transverse shaft, with rotary power transferred through a driving gear and a driven gear. The cleaning wheels are removably attached through wheel-axle mounts.

### BRIEF DESCRIPTION OF THE DRAWINGS

Reference will now be made to the drawings, wherein like parts are designated by like numerals, and wherein:

FIG. 1 is a perspective view of the grill cleaner apparatus of the invention in use;

FIG. 2 is a perspective lower view of the grill cleaner apparatus of the invention;

FIG. 3 is a perspective upper view of the grill cleaner apparatus of the invention;

FIG. 4 is a top view of the grill cleaner apparatus of the invention;

FIG. 5 is a bottom view of the grill cleaner apparatus of the invention;

FIG. 6 is a back view of the grill cleaner apparatus of the invention;

FIG. 7 is a front view of the grill cleaner apparatus of the invention;

FIG. 8 is a side view of the grill cleaner apparatus of the invention;

FIG. 9 is a bottom view of the grill cleaner apparatus of the invention in use with the cleaning wheels detached;

FIG. 10 is an exploded view of the grill cleaner apparatus of the invention;

FIG. 11 is a longitudinal section view of the grill cleaner apparatus of the invention; and

FIG. 12 is a transverse section view of the grill cleaner apparatus of the invention.

### DETAILED DESCRIPTION OF THE INVENTION

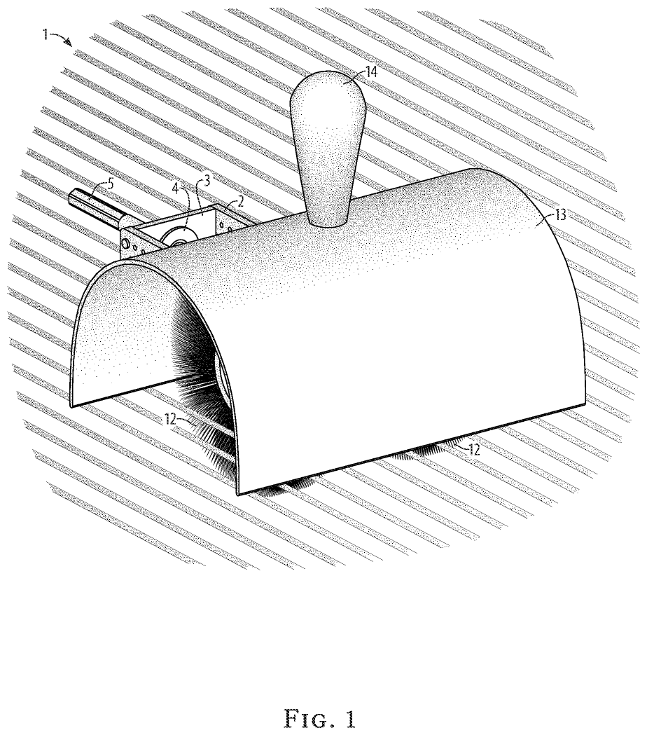

Referring to FIG. 1, the grill cleaner 1 is operated by attaching a source of rotary power such as a hand drill to the drive shaft 5, causing the cleaning wheels 12 to rotate and clean the grill. Rotation of the cleaning wheels 12 also propels the grill cleaner 1 forward along the grill. The grill cleaner 1 has a front to back, forward to rearward orientation with reference to its line of travel along the grill bars, and a top to bottom orientation with reference to its placement on the grill bars in use.

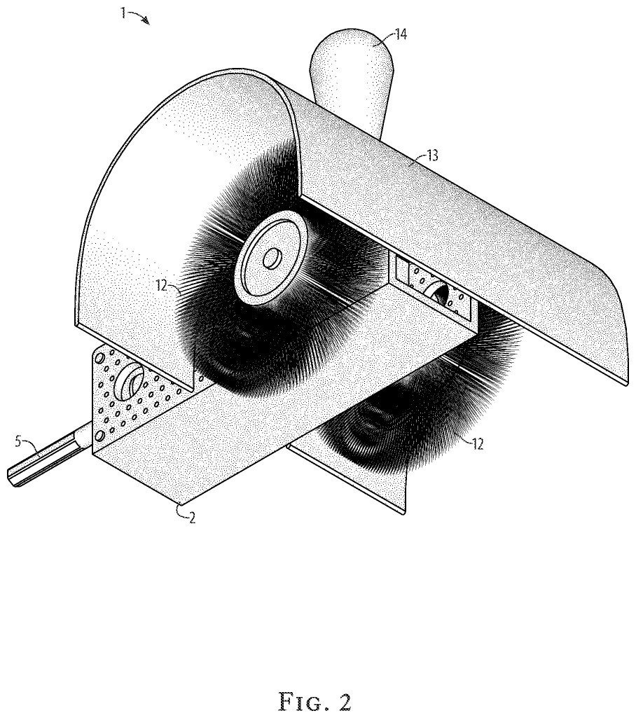

Referring to FIG. 2, the grill cleaner 1 provides a body unit 2 as a frame upon which to array the other components. In a preferred embodiment, the body unit is a metal channel with approximate dimensions of 1.5 inches width and height, and 5 inches length. The drive shaft 5 has a 0.25-inch diameter. The cleaning wheels 12 have 3-inch diameters.

The cleaning wheels 12 have abrasive material around the perimeters. In a preferred embodiment, the abrasive material is radiating wire bristles forming wire brushes. Such wire brushes are widely available at low expense, and can be readily replaced, as treated below. The cleaning wheels 12 can also have other abrasive materials such as plastic bristles or abrasive foams. The bristles of the cleaning wheels 12 should be flexible enough to allow the wheel perimeter to extend through the bars of the grill to more effectively clean the sides and undersides of the bars and to provide increased traction for propelling the grill cleaner 1 forward.

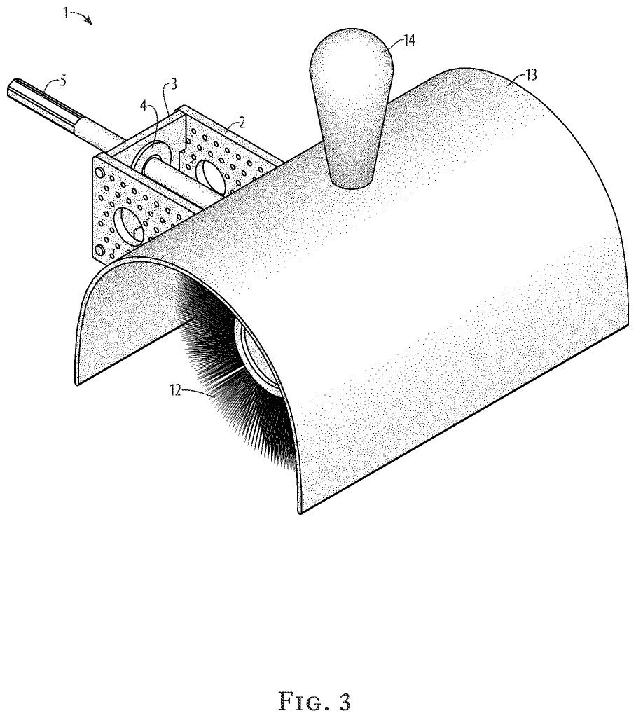

Referring to FIG. 3, the grill cleaner 1 provides a wheel cover 13 with an attached handle 14. The wheel cover 13 blocks the ejection of debris loosened by the cleaning wheels. The handle 14 provides a way for the user to move and place the grill cleaner 1 on different rows of grill bars. In a preferred embodiment, the wheel cover 13 is made of metal and measures approximately 5.5 inches across its forward edge. The wheel cover 13 can also be made of hard plastic or similar material. In a preferred embodiment, the handle is made of plastic or rubber and is approximately 5 inches long with an approximately 1.25-inch diameter.

Referring to FIG. 4, the grill cleaner 1 provides bearing supports 3 and bearings 4 mounted within the body unit 2. One bearing support 3 and bearing 4 is mounted at the back of the body unit 2, and supports the drive shaft 5.

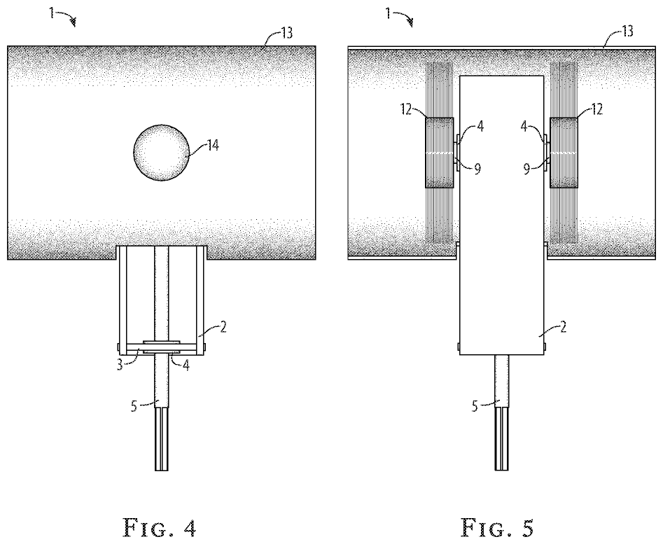

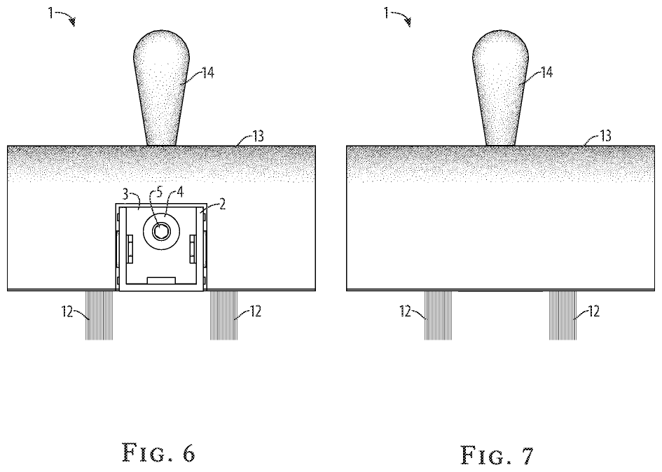

Referring to FIG. 5, the cleaning wheels 12 each provide a wheel axle 10 which is removably mounted to a wheel-axle mount 9, as treated below.

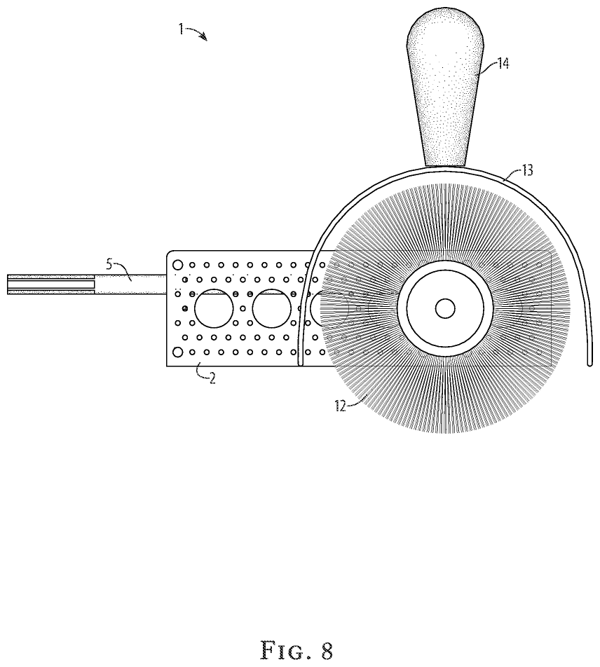

Referring to FIGS. 6 and 7, the cleaning wheels 12 extend below the body unit 2 so that the cleaning wheels 12 also extend between and below the grill bars. In a preferred embodiment, the cleaning wheels 12 extend approximately 0.75 inches below the body unit 2.

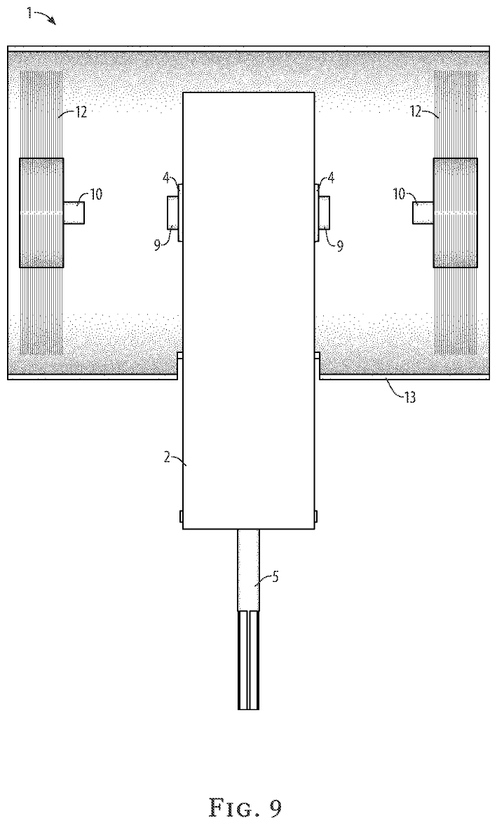

Referring to FIG. 8, in use, when rotary power is supplied to the drive shaft, the cleaning wheels 12 will rotate against and clean the grill bars, and the cleaning wheels 12 will also propel the grill cleaner 1 forward along the grill bars.

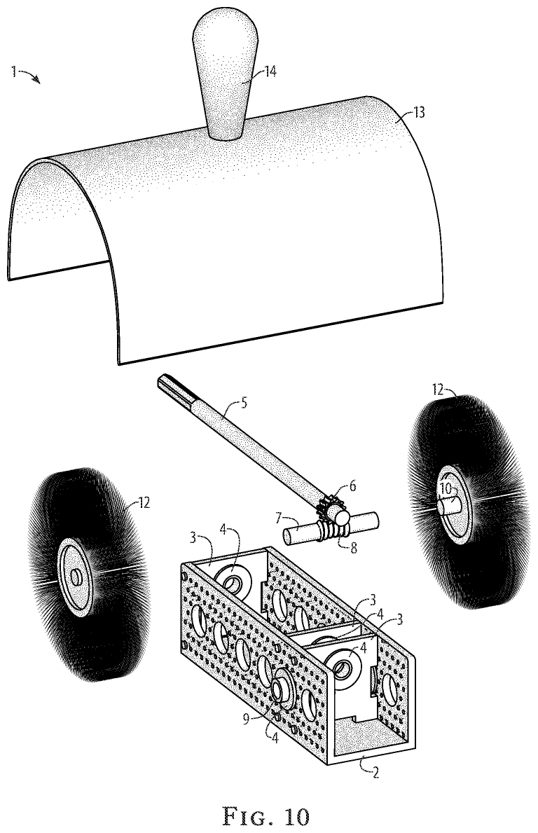

Referring to FIG. 9, the cleaning wheels 12 each have a wheel axle 10. The grill cleaner 1 provides a wheel-axle mount 10 for each wheel, providing an ability to remove the wheels for separate cleaning, for replacement, or for switching among different types of wheels.

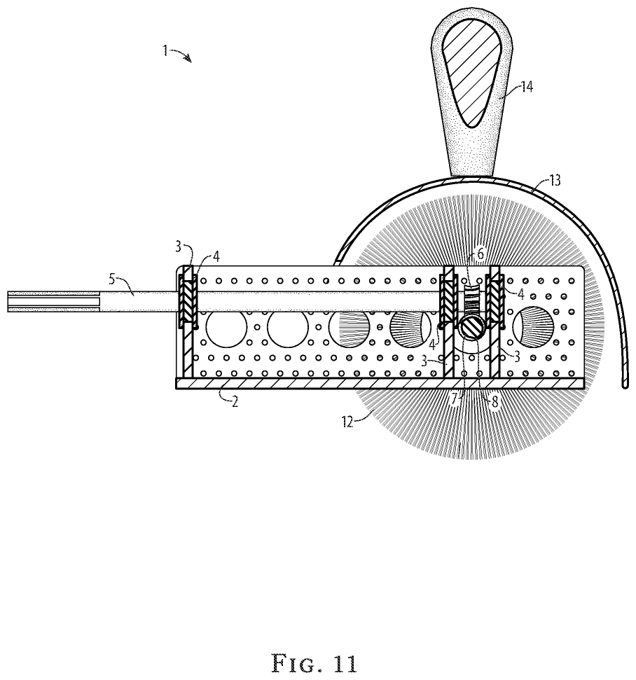

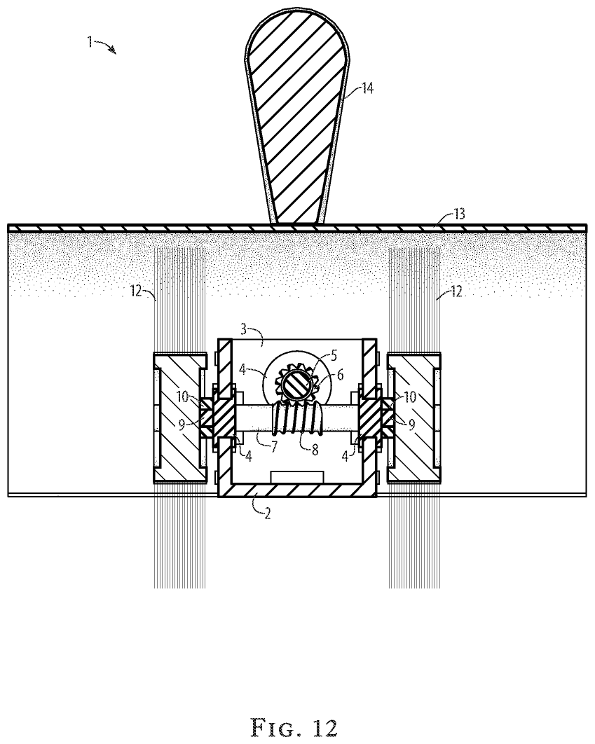

Referring to FIG. 10, exploded view, FIG. 11, longitudinal section view, and FIG. 12, transverse section view, the drive shaft 5 is supported within the body unit 2 by bearing supports 3 with bearings 4. At least two sets of bearing supports 3 and bearings 4 are necessary and are best located at the back and front of the body unit 2. More sets of bearing supports 3 and bearings 4 located between the back and front can provide additional support and stability to prevent displacement of the drive shaft 5 during use, as shown.

The cleaning wheels 12 are driven by one or two transverse shafts 7. In the illustrated embodiment, one transverse shaft 7 is provided to drive both cleaning wheels 12, other configurations providing two separate transverse shafts 7 are possible. The transverse shaft 7 drives the rotation of the cleaning wheels 12 so that both wheels rotate together and cooperatively to propel the grill cleaner 1 forward. The axis of rotation of the cleaning wheels 12 is perpendicular to the axis of rotation of the drive shaft 5.

A bearing 4 and wheel-axle mount 9 are provided for each cleaning wheel 12, as shown.

Rotary power is transferred from the drive shaft 5 to the transverse shaft 7 through at least one driving gear 6 mounted on the drive shaft 5 and at least one driven gear 8 mounted on the transverse shaft 7. In the illustrated embodiment with a single transverse shaft 7, a worm gear having one driving gear 6 and one driven gear 8 is shown. Other gear configurations are possible which provide more than one driving gear 6, driven gear 8, or both.

In the illustrated embodiment, two additional sets of bearing supports 3 and bearings 4 are provided in front and in back of the transverse shaft 7 and the driving gear 6 and driven gear 8, to support and stabilize the drive shaft 7 at that point where the operation of the gears would tend to displace the shaft.

Many other changes and modifications can be made in the system and method of the present invention without departing from the spirit thereof. I therefore pray that my rights to the present invention be limited only by the scope of the appended claims.

I claim:

1. A grill cleaner apparatus for cleaning a grill having grill bars with rotary power from an external source, the grill cleaner comprising:
(i) a body unit having a front, back, top, bottom, and sides;
(ii) at least two bearing supports mounted in said body unit, each having a mounted bearing;
(iii) a drive shaft mounted in said body unit and through said bearing supports with said bearings, and extending from the back of said body unit, adapted for attachment to an external source of rotary power;
(iv) at least one transverse shaft mounted in said body unit perpendicular to said drive shaft and extending to the sides of said body unit;
(v) two additional said bearings, each mounted on a side of said body unit at said transverse shaft;
(vi) at least one driving gear mounted on said drive shaft, adapted to transfer rotary power from said drive shaft;
(vii) at least one driven gear mounted on said transverse shaft, adapted to engage said driving gear to transfer rotary power to said transverse shaft;
(viii) two cleaning wheels, each having a wheel axle, adapted to clean grill bars and to propel said grill cleaner forward;
(ix) three wheel-axle mounts, mounted at the front end of said drive shaft and at the ends of said transverse shaft, adapted to removably couple said wheel axles to said drive shaft and said transverse shaft;
(x) a wheel cover at the top of said body unit, adapted to cover said cleaning wheels; and
(xi) a handle at the top of said body unit, adapted for manual movement of said grill cleaner.

2. The grill cleaner of claim 1, further comprising at least one additional bearing support having a mounted bearing mounted near said transverse shaft.

3. The grill cleaner of claim 1, where said at least one transverse shaft further comprises one transverse shaft.

4. The grill cleaner of claim 1, where said at least one driving gear further comprises one driving gear.

5. The grill cleaner of claim 1, where said at least one driven gear further comprises one driven gear.

6. The grill cleaner of claim 1, where said driving gear and said driven gear together comprise a worm gear.

7. The grill cleaner of claim 1, where said cleaning wheels are wire brush wheels.

8. The grill cleaner of claim 1, where said cleaning wheels further comprise being adapted to extend between and below the grill bars.

9. A grill cleaner apparatus for cleaning a grill having grill bars with rotary power from an external source, the grill cleaner comprising:
(i) a body unit having a front, back, top, bottom, and sides;
(ii) two bearing supports mounted in said body unit at the front and back, each having a mounted bearing;
(iii) a drive shaft mounted in said body unit and through said bearing supports with said bearings, and extending from the back of said body unit, adapted for attachment to an external source of rotary power;
(iv) a transverse shaft mounted in said body unit perpendicular to said drive shaft and extending to the sides of said body unit;
(v) two additional said bearings, each mounted on a side of said body unit at said transverse shaft;
(vi) a driving gear mounted on said drive shaft, adapted to transfer rotary power from said drive shaft;
(vii) a driven gear mounted on said transverse shaft, adapted to engage said driving gear to transfer rotary power to said transverse shaft;
(viii) at least one additional said bearing support having a mounted bearing mounted in said body unit adjacent to said transverse shaft;
(ix) two cleaning wheels, each having a wheel axle, adapted to clean grill bars and to propel said grill cleaner forward;
(x) three wheel-axle mounts, mounted at the front end of said drive shaft and at the ends of said transverse shaft, adapted to removably couple said wheel axles to said drive shaft and said transverse shaft;
(xi) a wheel cover at the top of said body unit, adapted to cover said cleaning wheels; and
(xii) a handle at the top of said body unit, adapted for manual movement of said grill cleaner.

10. The grill cleaner of claim 9, where said driving gear and said driven gear together comprise a worm gear.

11. The grill cleaner of claim 9, where said cleaning wheels are wire brush wheels.

12. The grill cleaner of claim 9, where said cleaning wheels further comprise being adapted to extend between and below the grill bars.
